(19) United States
(12) Patent Application Publication
(10) Pub. No.: US 2003/0076562 A1
(43) Pub. Date: Apr. 24, 2003

(54) High speed optical transmitter and receiver with a serializer with a minimum frequency generator

(75) Inventors: Seong S. Shin, Cupertino, CA (US); Yong Sung Jin, Sunnyvale, CA (US); Yung Sung Son, Sunnyvale, CA (US); Man Sung Choi, Soowon Kyunggi (KR)

Correspondence Address: SKJERVEN MORRILL LLP, 25 METRO DRIVE, SUITE 700, SAN JOSE, CA, 95110, US

(73) Assignee: Photonage, Inc.

(21) Appl. No.: 10/001,915

(22) Filed: Oct. 24, 2001

(51) Int. Cl. H04B 10/00

(52) U.S. Cl. 359/152; 359/154

(57) ABSTRACT

A minimum frequency generator of a transceiver system is presented. In a transmitter presented with K bits of parallel data, if a flip condition is determined and selected ones of the K bits are flipped, then the flip condition is signaled in a separately transmitted clock signal. The flip condition can be that all K bits are one or zero. Additionally, the clock signal can indicated whether bits are flipped or not by adjusting the duty cycle of the clock signal.

### BACKGROUND

1. Field of the Invention

The present invention relates to the transmission of serial optical data and, in particular, to a data frequency generator for insuring that the transmission of serial optical data has a minimum transition frequency.

2. Discussion of Related Art

High bandwidth data transmission can be achieved by the transmission of optical data between a transmitter and a receiver. Typically, serial data is transmitted optically between the transmitter and the receiver. In most conventional systems, optical data is transmitted as a series of timed light intensity levels with a high intensity level signifying a first logic level (e.g., logic one) and a low intensity level signifying a second logic level (e.g., logic zero). However, it is not uncommon, especially in transmission of graphic or video information, to transmit long strings of data having the same intensity level of light.

FIG. 1A shows an example of a conventional transmission system 100. Transmission system 100 transmits N parallel data bits. The N parallel data bits are input to laser diode drivers 101-1 through 101-N, one bit to each laser driver. Laser diode drivers 101-1 through 101-N drive laser diodes 102-1 through 102-N, respectively. The light from laser diodes 102-1 through 102-N is coupled into fibers 103-1 through 103-N, respectively. The light is retrieved from optical fibers 103-1 through 103-N by photodiodes 104-1 through 104-N, respectively. The signals from photodiodes 104-1 through 104-N are received in preamp and post amp block 105-1 through 105-N, which together outputs the N parallel data bits presented to transceiver 100. Transceiver system 100 shown in FIG. 1A, however, requires too many transmission lines, increasing the cost of system 100.

FIG. 1B shows another example of a conventional transmission system 100 which utilizes serializer deserializer (SERDES) system for transmitting data. In system 100 of FIG. 1B, the N parallel bits of data are separated into M subsets of K bits each (N=M*K). Each of the M subsets of K bits is input to serializers 110-1 through 110-M, respectively. Serializers 110-1 through 110-M each receives K parallel bits and outputs the K bits serially to laser diode drivers 111-1 through 111-M, respectively. Laser diode drivers 111-1 through 111-M drive laser diodes 112-1 through 112-M, respectively, so that the serial data output from serializers 110-1 through 110-M is transmitted optically.

The optical output signals from laser diodes 112-1 through 112-M are coupled into optical fibers 113-1 through 113-M, respectively. When transmitted to a particular location, the optical signals from optical fiber 113-1 through 113-M are received in photodiodes 114-1 through 114-M. The electrical signals from photodiodes 114-1 through 114-M are input to preamp and post amp blocks 115-1 through 115-M. The output signals from blocks 115-1 through 115-M are input to deserializers 116-1 through 116-M, respectively. Deserializers 116-1 through 116-M receives the M subsets of K serialized bits and outputs the K parallel bits. Additionally, a clock signal is transmitter through laser driver 117, laser diode 118, fiber 119, photodiode 120, and pre-amp and post amp 121. FIG. 1C shows an example timing diagram of the serialization and deserialization of data in system 100 of FIG. 100B.

Serializing the data can reduce the number of transmission lines. The frequency bandwidth required in the transmitted data is very wide, for example 0 Hz (DC) to K*Clock frequency/2. In an 8-bit serializer, for example, where the Clock frequency can be 100 MHz, the maximum serialized data frequency can be 400 MHz. If a long series of single intensity symbols are transmitted (e.g., all logic ones or all logic zeros), then the receiver may no longer be capable of distinguishing between the light intensity level corresponding to a logic one and the light intensity level corresponding to a logic zero.

In order to solve this problem and narrow the bandwidth, many conventional systems have extended the number of optical bits to avoid a low frequency data bits transition. For example, in order to transmit all possible eight bits of data, extended 10 bits of data, generated by mapping the eight bits of data to 10 bits, is transmitted. Other encoding procedures (e.g., 4B5B, 8B10B, 8B9B or TMDS encoding) can be utilized. For example, if 8B10B encoding is utilized, the maximum frequency of encoded serialized data is about 500 MHz (or about 1000 Mbps). The minimum frequency can be determined by the encoding. These types of data coding or encoding require lengthy calculation and extended data bits, which requires higher transmission data rates for transmission of the same information.

Therefore, an optical transceiver capable of meeting minimum frequency without increasing the number of transmitted data bits and which can be made with simple logic devices is desired.

### SUMMARY

In accordance with the present invention, an optical transceiver system is presented. In some embodiments, the transceiver system provides for minimum data frequency without utilizing extra optical data bits to transmit the data. An optical transceiver system includes an optical transmitter and an optical receiver. The optical transmitter can include a minimum frequency generator that monitors serial data so that if bits of data in a window of bits around a preselected bit or bits in a word of data all are set to the same logical level, then the preselected bit or bits are flipped to the opposite logic level. Additionally, a clock signal is encoded in order to signal the flipping of the preselected bit or bits.

In some embodiments, the transmitter is presented with a set of parallel bits. If all of the bits are 0 or all of the bits are 1, then a subset of the bits are flipped. For example, if K parallel bits are presented and all of them are 0 or all of them are 1, then K/2 can be flipped and the remaining bits remain unflipped. A flip signal can be encoded into the clock signal by, for example, adjusting the duty cycle of the clock signal. The receiver receives the serialized data stream from the transmitter and the clock signal. When the flip signal is detected, the K/2 bits which were flipped in the transmitter can be flipped again to retrieve the originally presented data.

In some embodiments, the transmitter includes M minimum data frequency multiplexers, each of the M minimum data frequency multiplexers receiving and transmitting a number of parallel bits. The number of parallel bits may be different for each of the M minimum data frequency multiplexers. The clock signal can encode a flip signal indicating that one of the M minimum data frequency multiplexers has flipped bits. A sequencer circuit can be utilized to determine which of the M minimum data frequency multiplexers is enabled to flip bits. A start signal can also be encoded into the clock signal so that a sequencer in the receiver can by synchronized with the transmitter's flip enabling selection sequence. Therefore, the flipped bits can be flipped again on the correct channel in the receiver.

In some embodiments, a word of data, which in some embodiments can include 6 bits, is accompanied by a clock signal which transitions high to signify the first bit of the word of data in a serial data stream that includes the word of data. A data frequency generator checks bits around a selected bit in the word of data and, if all of the bits are high or all of the bits are low, flips the selected bit. Additionally, a clock signal's duty cycle is encoded in order to signal the flipping of the preselected bit or the starting of the sequence order when multi-minimum data frequency multiplexer serial data are sent in parallel. For example, if the selected bit is not flipped, the clock may stay high for 3 bits and low for 3 bits. If the selected bit is flipped, however, the clock can stay high for a fewer number of bits (for example 1 or 2 bits) and low for the remainder (e.g., 5 or 4 bits, respectively). When the receiver receives the clock signal, the receiver determines based on the duty cycle of the clock signal whether the selected bit has been flipped or not.

In some embodiments of the invention, an optical transmitter with a laser diode driver and a serializer can be formed on a single integrated circuit. In some embodiments, the integrated circuit can also include a minimum frequency generator. In some embodiments of the invention, an optical receiver with a transimpedance amplifier and a deserializer are formed on a single integrated circuit. In some embodiments, the receiver includes a data recovery circuit capable of recovering data altered by the transmitter.

These and other embodiments are further discussed below with respect to the following figures.

### FIGURES

FIGS. 1A and 1B show prior-art transceiver systems.

FIG. 1C shows a data transmission timing sequence of the transmission system shown in FIG. 1B.

FIGS. 2A and 2B shows an example of a transceiver system according to the present invention.

FIG. 3 shows an embodiment of the minimum frequency generator shown in FIG. 2B.

FIGS. 4A, 4B, and 4C show a timing diagram of an example transmission in a transceiver according to the present invention.

FIG. 5A shows an embodiment of a transmitter of a transceiver system according to the present invention.

FIG. 5B shows an embodiment of a receiver of a transceiver system according to the present invention.

FIG. 6 shows an embodiment of a minimum data frequency multiplexer of a transmitter according to the present invention.

FIG. 7 shows an embodiment of a sequencer of a transmitter according to the present invention.

FIG. 8 shows an embodiment of a clock generator of a transmitter according to the present invention.

FIG. 9 shows an embodiment of a clock recovery of a receiver according to the present invention.

FIG. 10 shows an embodiment of a sequencer of a receiver according to the present invention.

FIG. 11 shows an embodiment of a deserializer of a receiver according to the present invention.

FIG. 12A shows a block diagram of an integrated circuit with a transmitter according to aspects of the present invention.

FIG. 12B shows a block diagram of an integrated circuit with a receiver according to the present invention.

In the figures, elements having the same designation have the same or similar functions.

### DETAILED DESCRIPTION

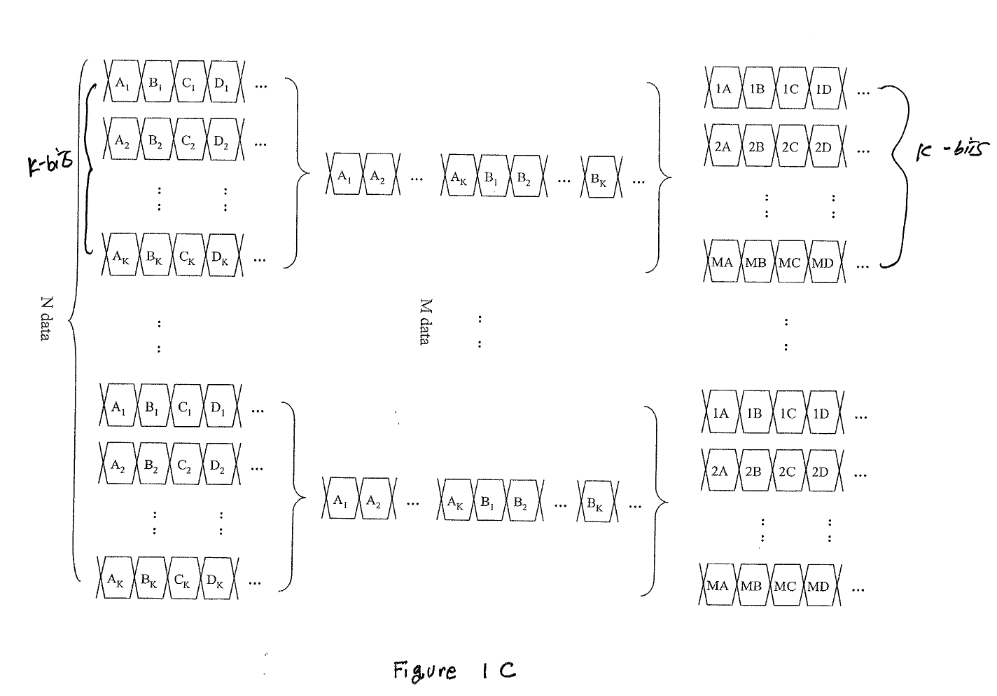

FIG. 2A shows a transceiver system 200 according to the present invention. Transceivers such as transceiver system 200 can be utilized in telecommunications systems, coupling data to HDTV displays, or in any other system that can benefit from high data transmission rates.

Transceiver system 200 includes a transmitter 210 coupled to a receiver 220 through optical fibers 201-1 through 201-M and optical fiber 202. Transmitter 210 provides optical data to optical fibers 201-1 through 201-M by converting electrical data signals to optical data signals in optical sources 214-1 through 214-M. Optical sources 214-1 through 214-M and 215 can be any light source capable of coupling optical data into optical fibers 201-1 through 201-M and 202. Optical signals from optical fibers 201-1 through 201-M and 202 are detected by optical detectors 224-1 through 224-M and 225 of receiver 220. Optical detectors 224-1 through 224-M and 225 can be any optical detector capable of detecting light transmitted on optical fibers 201-1 through 201-M and 202 by optical sources 214-1 through 214-N and 215. Transmitter 215 transmits M minimum data frequency multiplexers of serial optical data on optical fibers 201-1 through 201-M and an optical clock signal on optical fiber 202.

Transmitter 210 includes minimum data frequency multiplexers 211-1 through 211-M, a clock generator 212, and a sequence generator 213. Optical sources 214-1 through 214-M receive the data signals output from minimum data frequency multiplexers 211-1 through 211-M, respectively. Additionally, minimum data frequency multiplexers 211-1 through 211-M receives a data stream with M parallel sets of K bits D1 through DK_{M}. A clock signal CLK appropriate for the N=ΣKᵢ serial data streams D1C1 through DK_{N}CM (with D1C1 indicating the D1 data stream of channel 1 and DK_{M}CM indicating the K_{M}th bit of the data stream of channel M). In other words, each of the data streams D1C1 through DK_{M}CM are synchronized to a single clock signal CLK. In some embodiments, each of minimum data frequency multiplexers 211-1 through 211-M receives a different number Kᵢ, i equal to 1 through M, of parallel data bits.

The optical signals from optical sources 214-1 through 214-M are coupled into optical fibers 201-1 through 201-M, respectively. Receiver 220 receives the optical signals corresponding to the serialized input data to transmitter 210 in optical detectors 224-1 through 224-M, respectively. Optical detectors 224-1 through 224-M can be any optical detector which converts optical signals to electrical signals. The electrical signals from optical detectors 224-1 through 224-M are input to deserializers 221-1 through 221-M. Deserializers 221-1 through 221-M recover the transmitted data and outputs parallel sets of data with K₁ through K_{M} numbers of bits, respectively.

A clock signal is input to clock generator 212. Clock generator 212 outputs a clock signal to optical source 215, which is coupled through optical fiber 202 to optical detector 225 of receiver 220. In order to maintain a minimum data frequency, minimum data frequency multiplexers 211-1 through 211-M each monitor the K₁ through K_{M}, respectively, parallel bits and, under particular conditions, flips some of the bits (i.e., a 0 bit becomes a 1 bit) in that set of parallel bits. In some embodiments, minimum data frequency multiplexer 211-j, an arbitrary one of minimum data frequency multiplexers 211-1 through 211-M, flips the last Kⱼ/2 bits if all of the Kⱼ bits input to it are either all 0 or all 1 and sequence generator 213 has enabled minimum data frequency multiplexer 211-j.

Sequence generator (sequencer) 213 outputs a signal which enables one of minimum data frequency multiplexers 211-1 through 211-M to flip bits. In some embodiments, sequence generator 213 sequentially enables each of minimum data frequency multiplexers 211-1 through 211-M. When a subset of bits has been flipped, then clock generator 212 outputs a clock signal having a different duty cycle than if bits have not been flipped. For example, clock generator 212 may output a clock signal having less than 50% duty cycle if no bits have been flipped and greater than 50% duty cycle if bits have been flipped.

The output signal from clock generator 212 can be converted to an optical signal in optical source 215 and transmitted on optical fiber 202 to optical detector 225 in receiver 220. Optical detector 225 receives the optical clock signal from optical fiber 202 and converts the optical signal to an electrical signal. The electrical signal from optical detector 225 is received by clock recovery 222. Clock recovery 222 not only recovers the clock signal, but also determines the duty cycle of the received clock signal in order to signal whether bits have been flipped in transmitter 210 or not. Serialized data from optical fibers 201-1 through 201-M are received in optical detectors 224-1 through 224-M, respectively, and the corresponding electrical signals are input to deserializers 221-1 through 221-M, respectively.

Sequence generator (sequencer) 223 can be coordinated with sequence generator (sequencer) 213 so that if bits have been flipped by minimum data frequency multiplexer 211-j the original data is recovered in deserializer 221-j. In some embodiments, sequence generator 223 may be started in response to a start signal encoded in the clock signal from optical fiber 202 on startup of the chip so that sequence generator 223 is synchronized with data received at optical detectors 224-1 through 224-M.

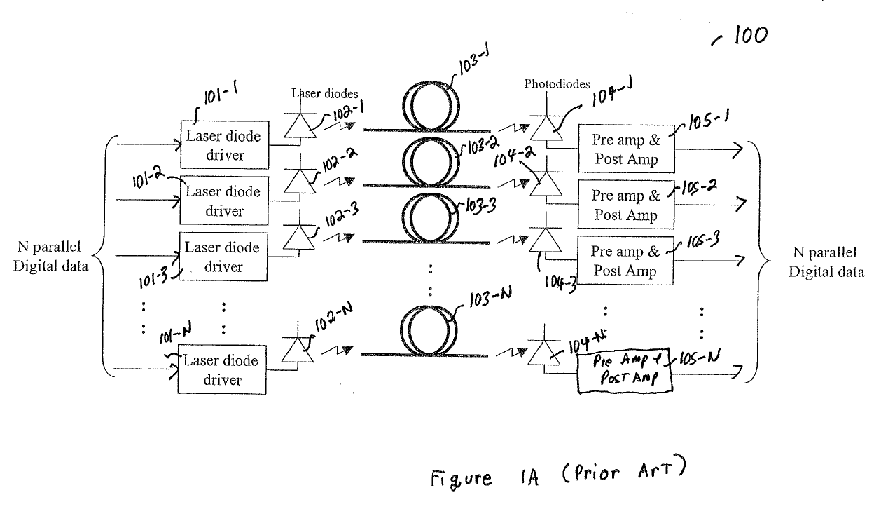

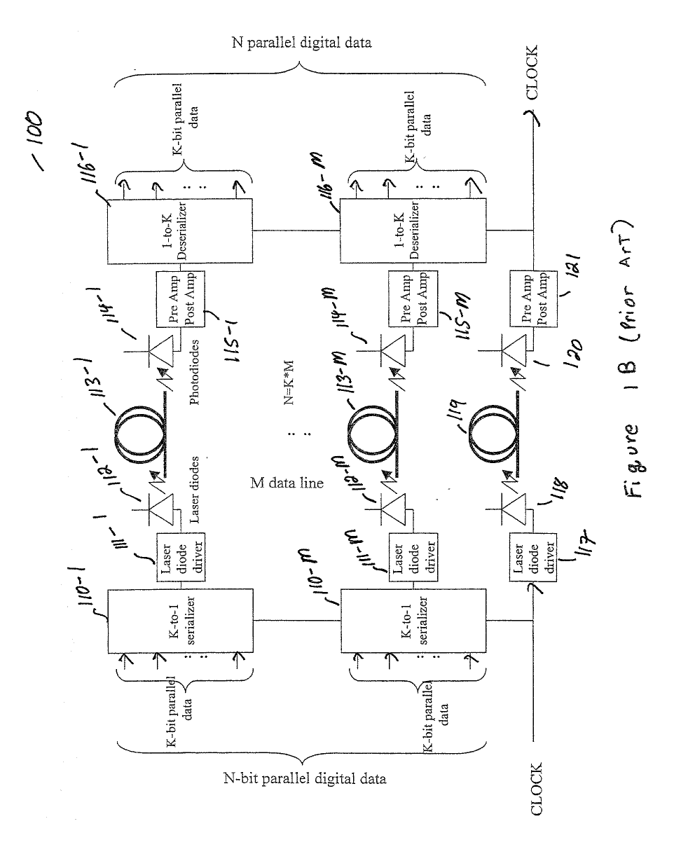

FIG. 2B shows a more detailed block diagram of an embodiment of a transceiver according to the present invention. As shown in FIG. 2A, each of minimum data frequency multiplexers 211-1 through 211-M of transmitter 210 shown in FIG. 1B receives a series of parallel data bits K₁ through K_{M}, respectively. Minimum data frequency multiplexers 211-1 through 211-M serializes the parallel bits K₁ through K_{M} and outputs the parallel data stream to optical sources 214-1 through 214-M, respectively, for transmission to receiver 220 over optical fibers 201-1 through 201-M, respectively. Receiver 220 receives the serial data from optical fibers 201-1 through 201-M in optical detectors 224-1 through 224-M, respectively. The electrical signals corresponding to the serial optical data is then deserialized, recovered, and output from receiver 220 in deserializers 221-1 through 221-M, as described above with FIG. 2A.

Optical sources 214-1 through 214-M of FIG. 2B each include a laser diode driver 250-1 through 250-M, respectively. Each of laser diode drivers 250-1 through 250-M are coupled to laser diodes 252-1 through 252-M, respectively. Similarly, optical detectors 224-1 through 224-M each include a photo diode 254-1 through 254-M, respectively, coupled to an amplifier 255-1 through 255-M, respectively. Amplifiers 255-1 through 255-M may, for example, by transimpedance amplifiers. Additionally, optical source 215 includes a laser diode driver 251 coupled to a laser diode 253. Furthermore, optical detector 225 includes a photodiode 255 coupled to an amplifier 256.

Although the transmission medium shown in FIGS. 2A and 2B are optical fibers, optical fibers 201-1 through 201-M and 202 may be replaced by any transmission medium, including infrared, wireless, copper, or other medium. In which case, sources 214-1 through 214-M and 215, along with detectors 224-1 through 224-M and 225 are replaced with the appropriate source and corresponding detector.

Minimum data frequency multiplexers 211-1 through 211-M each includes a minimum frequency generator 257-1 through 257-M, respectively, coupled to a serializer 258-1 through 258-M, respectively. Minimum frequency generator 257-1 through 257-M each receives the K₁ through K_{M} parallel bits and determines whether some of those bits should be flipped. If, in minimum frequency generator 257-j, the bits should be flipped and minimum frequency generator 257-j is enabled by sequence generator 213, then minimum frequency generator 257-j flips some of the Kⱼ bits.

Deserializers 221-1 through 221-M each include a deserializer 259-1 through 259-M, respectively, coupled to a data recovery 260-1 through 260-M, respectively. If clock generator 222 detects from the transmitted clock signal that bits have been flipped, then whichever one of deserializers 259-1 through 259-M is enabled flips the corresponding bits in the input data. Data recovery 260-1 through 260-M, then, can perform equalization and other receiver functions.

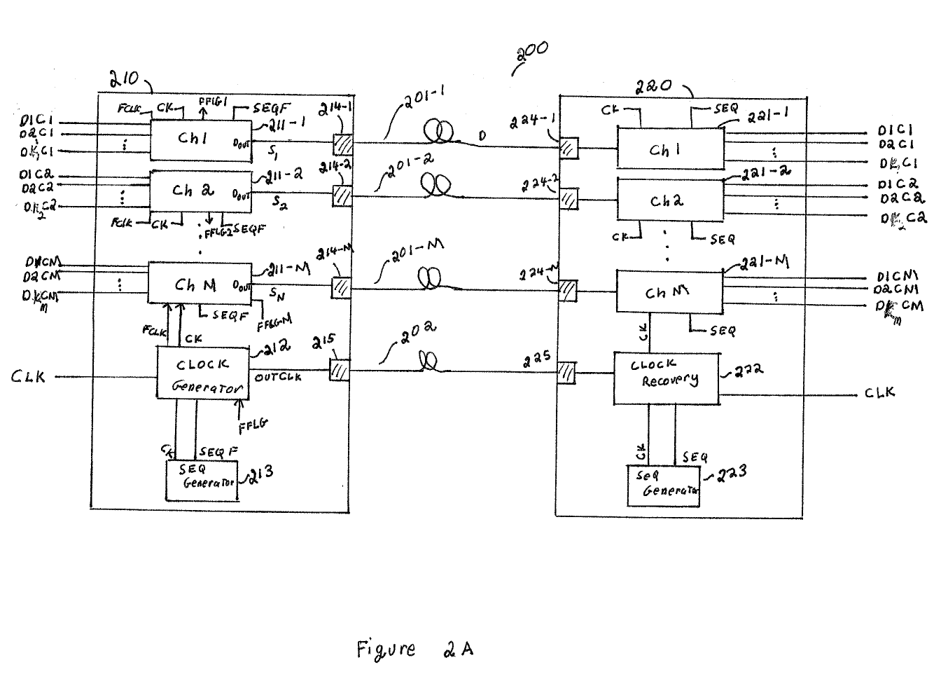

FIG. 3 shows a block diagram of an embodiment of minimum frequency generator 257-j. Minimum frequency generator 257-j is coupled to serializer 258-j and coupled to sequencer 213 and clock generator 212. The Kⱼ parallel bits are input to an all 0 or all 1 detector 302. All 0 or all 1 detector 302 enables inverter 301 if all of the Kⱼ bits are 0 or all of Kⱼ bits are 1 and minimum frequency generator 257-j is enabled by sequencer 213. Inverter receives some of the Kⱼ parallel bits, Kⱼ/2 in FIG. 3 but any number of bits less than Kⱼ can be input to inverter 301. When enabled, inverter 301 inverts the bits input to it. The Kⱼ bits, including those output from inverter 301, are then input to serializer 258-j.

An example serial output is also illustrated in FIG. 3. The example shown in FIG. 3 includes eight parallel bits, B0 through B7, input to minimum frequency generator 257-j. If the parallel set of bits (0,0,0,0,0,0,0,0) is input to minimum frequency generator 257-j, then all 0 or all 1 detector 302 can indicate that they are all the same and, if sequencer 213 has enabled minimum frequency generator 257-j, will enable inverter 301. If inverter is enabled, then bits (B7:B4) can be inverted, yielding the parallel set of bits (0,0,0,0,1,1,1,1) which can then be serialized in serializer 258-j to generate the serial bit stream (00001111). If inverter 301 flips the bits (7:4), then clock generator 212 outputs a clock signal with a duty cycle greater than 50%, e.g. the clock signal which can be represented serially as (00011111). If minimum frequency generator 257-j is not enabled and inverter 301 does not flip the bits (B7:B4), then the parallel set of bits (0,0,0,0,0,0,0) is serialized in serializer 258-j to generate the serial bit stream (00000000) and clock generator 212 outputs a clock signal with a duty cycle less than or equal to 50%, e.g. (00000111). As another example, the parallel set of bits (0,1,0,0,1,1,0,0) will not be inverted in inverter 301 even if minimum frequency generator 257-j is enabled by sequencer 213 so that the serialized output signal from serializer 258-j is (01001100) and the clock signal from clock generator 212 has a duty cycle less than or equal to 50%, e.g. (00001111).

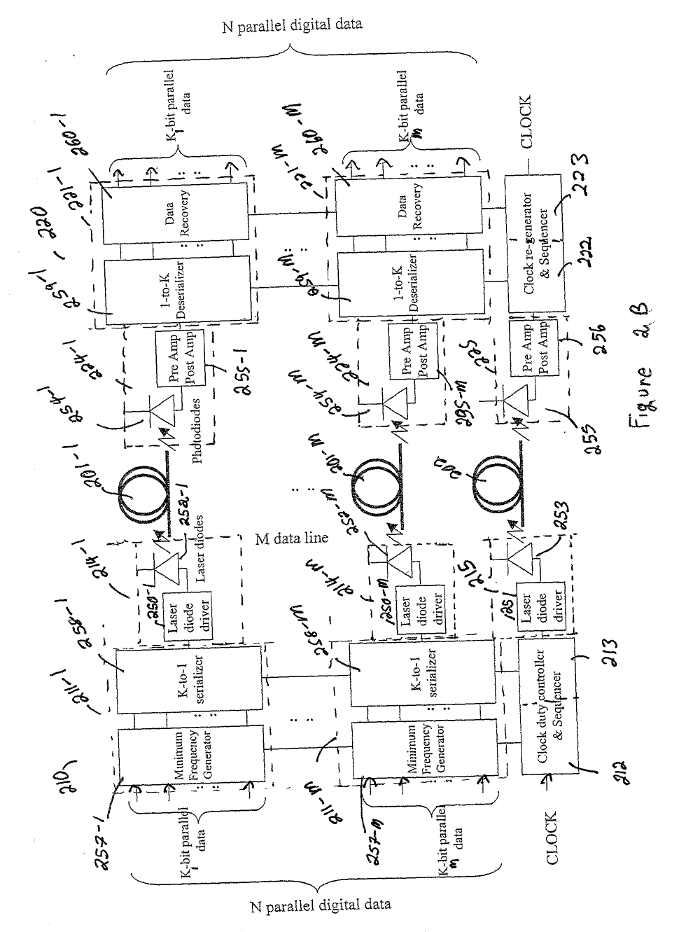

As another example, FIG. 4A shows a timing diagram for parallel data input to minimum data frequency multiplexer 211-j, an arbitrary one of minimum data frequency multiplexers 211-1 through 211-M of minimum frequency transmitter 210. FIG. 4A shows four sequential time periods n, n+1, n+2 and n+3. During time periods n+1 and n+3, minimum data frequency multiplexer 211-j is enabled by sequence generator 213. During time periods n and n+2, minimum data frequency multiplexer 211-j is not enabled. For illustrative purposes, 4 parallel bits of data are input during each time period. The parallel bits (1,0,0,1) are input during time period n, (0,0,0,0) are input in time period n+1, (1,1,1,1) are input in time period n+2, and (0,1,1,0) are input in time period n+3. The parallel data is presented to minimum data frequency multiplexer 211-j synchronously with a clock signal with period T.

FIG. 4B shows the resulting data presented to optical source 214-j according to some embodiments of the present invention. During time period n, the parallel bits (1,0,0,1) are input to minimum data frequency multiplexer 211-j. Since not all of the bits are the same and minimum data frequency multiplexer 211-j is not enabled during time period n, the parallel bits (1, 0, 0, 1) asserted in time period n are then serialized to the bit sequence (1001) and transmitted over optical fiber 201-j along with a clock signal with a duty cycle less than 50%. In the time period n+1, minimum data frequency multiplexer 211-j is enabled and the parallel bits (0,0,0,0) are presented. According to the present invention, some of the bits are flipped yielding the serialized bit stream (0011). Additionally, the clock signal generated by clock generator 212 has a duty cycle greater than 50% to signal to receiver 220 that bits have been flipped. In time period n+2, the parallel bits (1,1,1,1) are presented to minimum data frequency multiplexer 211-j, but minimum data frequency multiplexer 211-j is not enabled so the serial bits (1111) are output with a clock signal having a duty cycle less than 50% signifying that no bits have been flipped. In time period n+3, the parallel bits (0,1,1,0) are presented to minimum data frequency multiplexer 211-j and minimum data frequency multiplexer 211-j is enabled, but all of the bits are not the same so none are flipped. Minimum data frequency multiplexer 211-j then outputs a sequence (0110) and the clock signal has a duty cycle less than 50% signifying no flipped bits.

FIG. 4C illustrates the output signals from deserializer 221-j which receives the bit stream from optical fiber 201-j. The clock signal on optical fiber 202 is received in clock recovery 222, which indicates whether the clock signal is signaling flipped bits or not. Additionally, sequence generator 223 is synchronized such that when the data stream shown in FIG. 4B is presented to deserializer 221-j, the enable signal is the same as shown in FIG. 4A. Additionally, the clock signals shown in 4A and 4C are shown to have the same period as the transmitted clock signal shown in FIG. 4B.

Although in many of the examples presented, a transmitted clock signal having greater than 50% duty cycle signifies flipped bits while a clock signal having less than or equal to 50% duty cycle signifies that no bits have been flipped, any signal on the clock signal can be utilized. For example, a signal having greater than 75% duty cycle signifies no flipped bits and a signal having less than 25% duty cycle signifies flipped bits. Additionally, in the particular example shown in FIGS. 4A, 4B and 4C, 4-bit parallel data is presented to minimum data frequency multiplexer 211-j. Any number of bits may be presented to minimum data frequency multiplexer 211-j. Additionally, the serialization can be performed in any sequence. For example, K parallel bits may be separated into two data streams and “shuffled” in the serialization process.

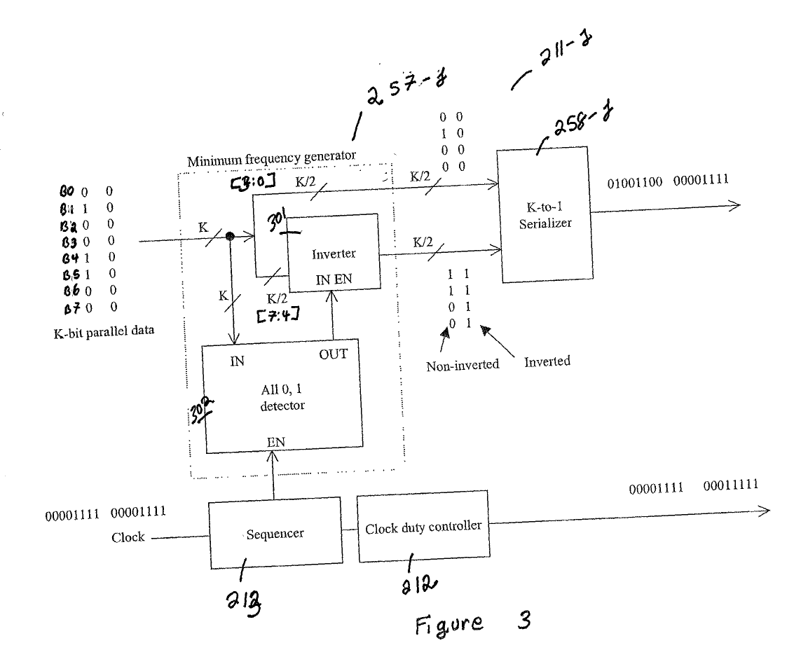

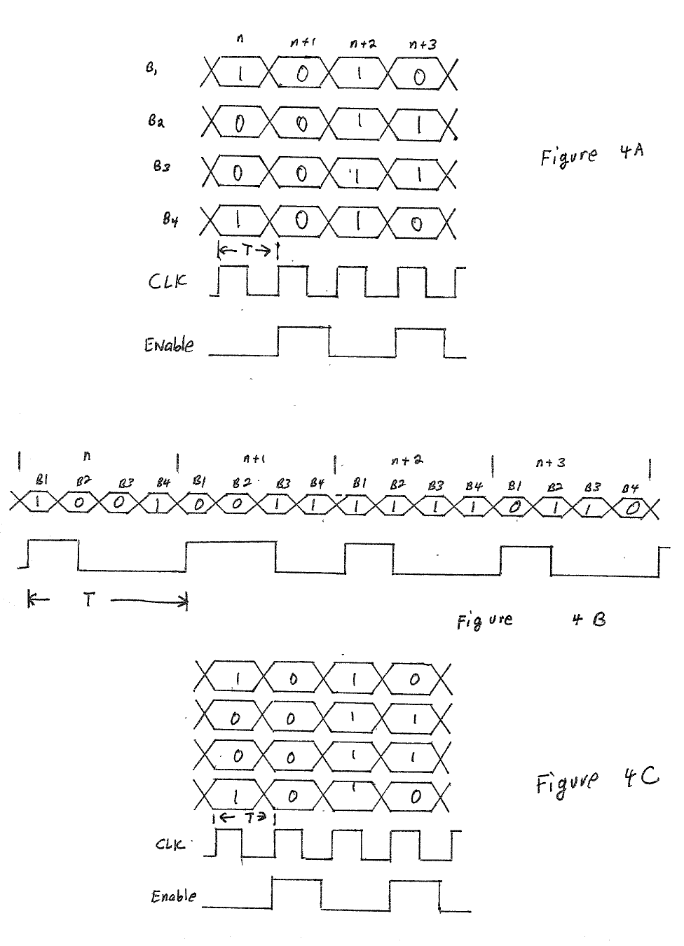

FIGS. 5A and 5B show another embodiment of a transmitter 210 and a receiver 220, respectively, of a transceiver 200 according to the present invention. As shown in FIG. 5A, sequencer 213 outputs an enable signal for each of minimum data frequency multiplexers 211-1 through 211-M, CH1_EN through CHM_EN, respectively. Each of minimum data frequency multiplexers 211-1 through 211-M includes a pipeline 502-1 through 502-M, respectively, to receive the parallel sets of bits input to minimum data frequency multiplexers 211-1 through 211-M, respectively. Additionally, whether all of the bits are 0 or 1 is determined in blocks 503-1 through 503-M of minimum data frequency multiplexers 211-1 through 211-M, respectively. Sequencer 513 can enable one of minimum data frequency multiplexers 211-1 through 211-M during each time period. If, for example, minimum data frequency multiplexer 211-j is enabled, minimum data frequency multiplexer 211-j being an arbitrary one of minimum data frequency multiplexers 211-1 through 211-M, and block 503-j indicates that all of the parallel bits are the same, then minimum data frequency multiplexer 211-j indicates a CHj_flip flag from logic block 505-j. If one of the CHj_flip flags are set, then logic block 501 indicates a flip condition to clock generator 212, which adjusts the duty cycle of the transmitted clock signal to signify a flip condition. Additionally, if CHj_flip is set, then multiplexer 504-j chooses the data stream from pipelined data 502-j with selected inverted bits and data output 506-j outputs the serialized data.

FIG. 5B shows a corresponding receiver 220 to transmitter 210 shown in FIG. 5A. Receiver 220 includes deserializers 221-1 through 221-M, clock recovery 222, and sequencer 223. Clock recovery 222 receives the transmitted clock signal and determines from the duty cycle whether a flip condition exists. Further, clock recovery 222 indicates a start condition received, where the start condition can also be signaled on the clock signal. Sequencer 223 then enables deserializers 221-1 through 221-M in the same fashion as minimum data frequency multiplexers 211-1 through 211-M were enabled in transmitter 210. Each of deserializers 221-1 through 221-M includes a data recovery 510-1 through 510-M, respectively, and a receive buffer 512-1 through 512-M, respectively. Deserializers 221-1 through 221-M also include multiplexers 511-1 through 511-M and logic circuits 513-1 through 513-M. In deserializer 221-j, for example, if the flip condition exists and if CHj_EN indicates that deserializer 221-j is enabled, then multiplexer 511-j chooses a data stream where the flipped bits are flipped again, recovering the originally transmitted bit stream. The data is placed in parallel format in buffers 512-1 through 512-M.

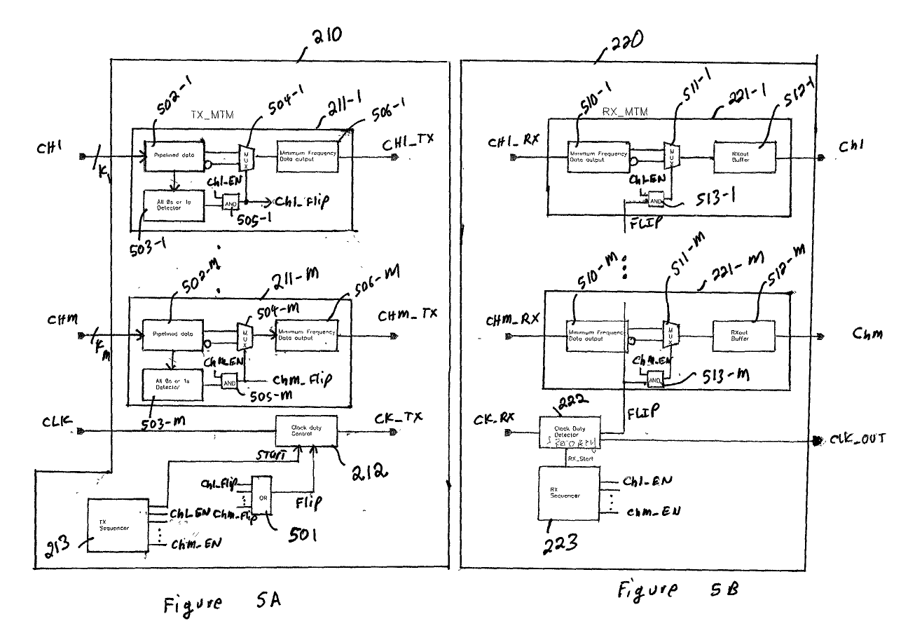

FIGS. 6 through 11 illustrate a particular embodiment of transceiver 200 according to the present invention. In this embodiment, M is four and K is six for each of the four minimum data frequency multiplexers 211-1 through 211-4. From this particular example, one skilled in the art will recognize how transceiver 200 can include an arbitrary number of minimum data frequency multiplexers 211-1 through 211-M, each receiving an arbitrary number of parallel bits of data during each clock cycle.

FIG. 6 shows an embodiment of minimum data frequency multiplexer 211-j as shown in FIG. 5A. The particular embodiment shown in FIG. 6 receives six parallel bits of data B0 through B5. One skilled in the art will recognize how to modify FIG. 6 for any number of parallel bits. The six parallel bits of data B0 through B5 are received in multiplexers 601 and 602 of pipeline 502-j. Pipeline 502-j also includes serially coupled registers 603, 604, and 605 along with serially coupled registers 606 and 607 with registers 608 and 609 and inverter 610, forming two parallel data paths.

Multiplexer 601 receives bits B0, B1 and B2 and sequentially passes them to register 603. Multiplexer 601 is controlled with selection signal SEL, which is clocked with clock signal OD, which in this embodiment has a clock frequency three times the frequency with which parallel data is presented. Therefore, bits B0, B1 and B2 are clocked sequentially into registers 603, 604 and 605.

Multiplexer 602 receives bits B3, B4 and B5 and sequentially passes them to register 606. Bits B3, B4 and B5, then, are sequentially clocked through registers 606, 607 and 609. Additionally, from inverter 610, the flipped bits are sequentially clocked into register 608.

At the end of three clock cycles of clock signal OD, bits B0, B1 and B2 are stored in registers 603, 604 and 605 and bits B3, B4 and B5 are stored in registers 606, 607 and 609. Logic block 611 checks to see if the output signals from registers 603, 604 and 605 are all zeros (indicated by signal NA7) or all ones (indicated by signal NA6). Similarly, logic block 612 indicates whether the output signals from registers 606, 607 and 609 are all zeros (indicated by signal NB8) or all ones (indicated by signal NB10). The output signals from logic block 611 are stored in registers 613 and 614 and the output signals from logic block 612 are stored in registers 615 and 616. Registers 613, 614, 615 and 616 are clocked with signal P7, which has the frequency that data is presented to minimum data frequency multiplexer 211-j. The logic check on all zeros or all ones performed by logic blocks 611 and 612, then, is captured at the time when bits B0 through B5 are stored in registers 603, 604, 605, 606, 607, and 609 and the results of the check are stored while bits B0 through B5 are processed.

The stored signals NFA0 and NFA1 from registers 613 and 614, respectively, indicate whether bits B0, B1 and B2 are all zero or all one and the stored signals NFB0 and NFB1 from registers 615 and 616 indicate whether bits B3, B4 and B5 are all zero or all one. The signals NFA0, NFA1, NFB0, and NFB1 are input to logic 618 along with the CHj_EN signal from sequencer 213. From logic 618, if all bits B0 through B5 are zero or one and CHj_EN is set, then a flip signal is presented to register 617. Register 617 is clocked by a signal P9 which has the same frequency as clock signal P7 but is phase separated from clock signal P7 by ⅙ the frequency of clock signal P7.

The flip signal from register 617 controls multiplexer 504-j so that if a flip condition exists, multiplexer 504-j chooses the flipped bits stored in register 608 rather than the unflipped bits stored on register 609. The output signal from multiplexer 504-j is then input to register 619, which is clocked by clock signal OD.

Data output 506-j includes multiplexer 620 and output register 621. Multiplexer 620 toggles between selecting the output signal from register 605 and the output signal from register 619 with a clock signal CHSL having a frequency twice that of clock signal OD. Additionally, the output signal from multiplexer 620 is clocked into register 621 with a clock signal A1 having a frequency the same as that of the switching clock signal to multiplexer 620. In some embodiments, phase shifts may be introduced between clock signals A1 and CHs1 in order to facilitate capture of the serialized data. The serialized output data CHj_TX is then the output signal from register 621.

As an example, if the parallel bits (0,0,0,0,0,0) were presented to multiplexers 601 and 602, then the serial bit stream (010101) would be generated if minimum data frequency multiplexer 211-j is enabled. Similarly, the parallel bits (1,1,1,0,0,0) are presented to multiplexers 601 and 602, then the serial bit stream (101010) would be generated regardless of whether minimum data frequency multiplexer 211-j is enabled or not. In general, with bits (B0, B1, B2, B3, B4, B5) are input to multiplexers 601 and 602, then the bit sequence (B0 B3 B1 B4 B2 B5) is output. If the flip condition is met (e.g.., minimum data frequency multiplexer 211-j is enabled and all the bits are the same), bits B3, B4 and B5 are flipped in the sequential output signal. In some embodiments of the invention, only one of the bits may be flipped.

One skilled in the art will recognize that more parallel bits of data can be included by included additional sets of series coupled registers or by adding more registers in series with those already present. For example, eight bits can be received if the output signal from register 605 is input to another register and if the output signal from register 607 is input to another register which is coupled to inverter 610. Additionally, then, the clock signal OD would be 4 times the frequency of the clock signal with which data is presented to multiplexers 601 and 602 rather than three times that frequency, as is shown in FIG. 6. Additionally, the clock signal AL would then be eight times the clock frequency rather than six times the clock signal, as is shown in FIG. 6.

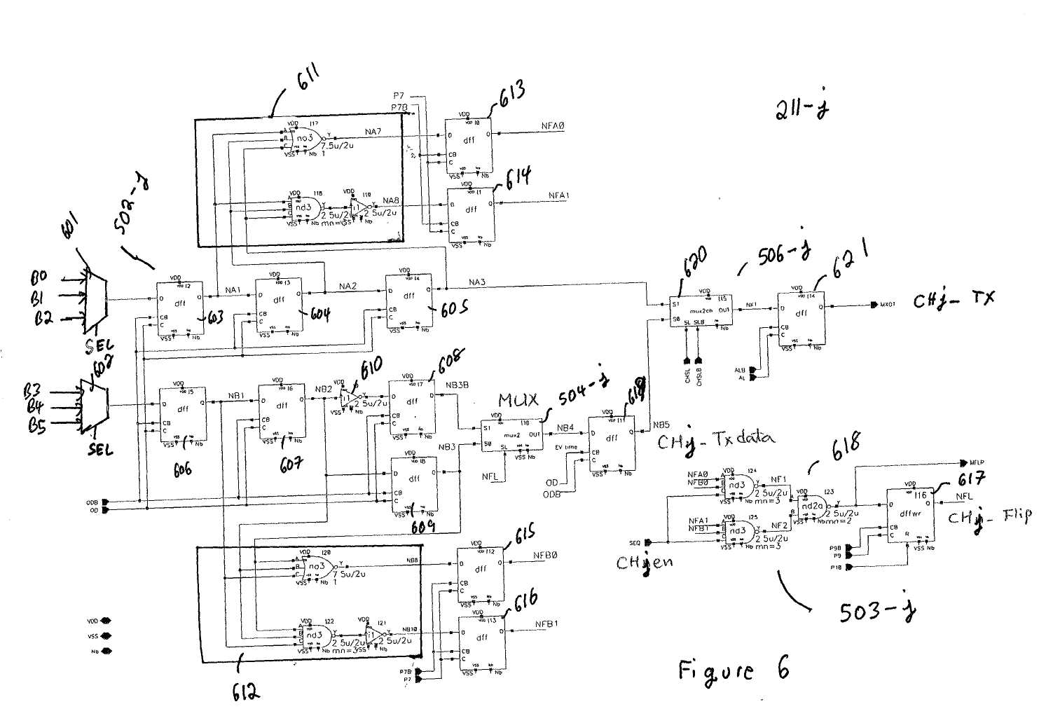

FIG. 7 shows an embodiment of sequencer 213 of transmitter 210. Sequencer 213 sequentially enables minimum data frequency multiplexers 211-1 through 211-M. Logic 710 resets each of sequentially coupled registers 721, 722, and 723 of counter block 720. The inverted output of register 723 is input to register 721. Registers 721, 722 and 723 are clocked by signal PDVCD, which has the same frequency with which data is presented to transmitter 211. From reset, then, registers 721, 722 and 723 have outputs S0, S1, S2 equal to (0,0,0), (1,0,0), (1,1,0), (1,1,1), and (0,1,1). After the values (0,1,1) have been attained, logic 710 resets registers 721, 722 and 723 to (0,0,0). The signal MSTR is enabled on (0,0,0) while CH1_EN is set with values (1,0,0), CH2_EN is set with values (1,1,0), CH3_EN is set with values (1,1,1), and CH4_EN is set with values (0,1,1). The signal Men enables sequencer 213. Therefore, no enable signals are set until sequencer 213 is itself enabled. The MSTR enable signal is useful to start sequencer 223 of receiver 220 and keep sequencer 223 synchronized with data transmitted from transmitter 210.

Sequencer 213 can enable more than four minimum data frequency multiplexers 211-1 through 211-4 by adding more registers to counter block 720. The larger the number of registers coupled in series, the more combinations of bits can be generated which will yield a larger number of enable signals in logic block 730. Unused combinations of bits can be discarded by appropriately resetting the registers in counter block 720.

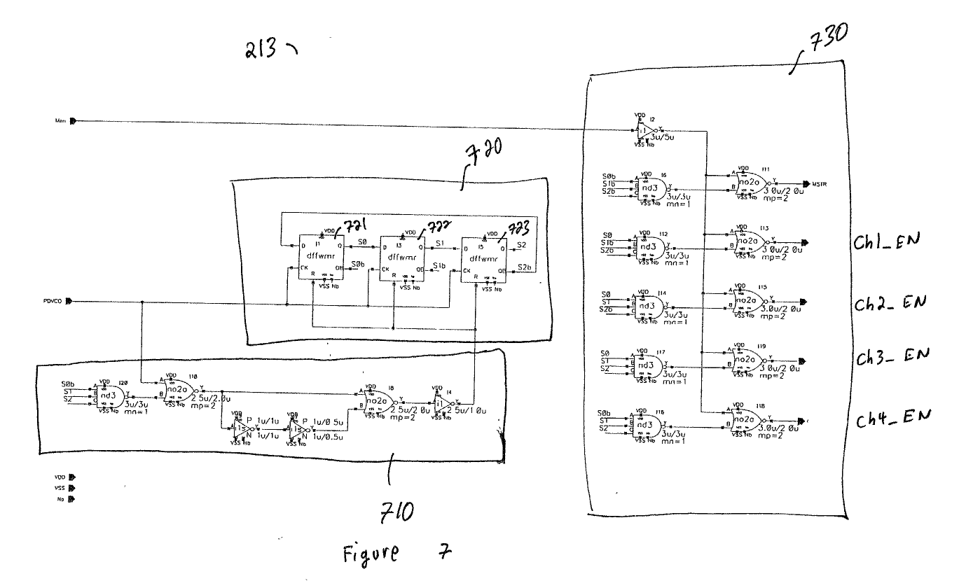

FIG. 8 shows an embodiment of clock generator 212. The clock signal input to clock generator 212 can be represented as (011), with greater than a 50% duty cycle. In an embodiment with six parallel bits, the serialized data is transmitted at a data rate six times that of the clock signal input to clock generator 212. Registers 803, 804 and 805 are clocked with clock signal OD, which has a frequency three times that of the clock signal. Logic block 501 determines whether a flip signal is present and the result is stored in register 808. Register 8 is clocked with a clock signal DP9. Register 807 stores the MSTR signal from sequence generator 213. Register 807 is clocked with a clock signal DP8. Clock signals DP9 and DP8 each are at the frequency with which parallel data is presented to transmit channel 211-j (FIG. 2). The clock signals DP8 and DP9, however, have different phases. Therefore, when the clock signal is being passed and delayed through registers 803, 804, 805 and 806, if there is a flip signal or a master signal output from registers 807 and 808, respectively, then register 804 is reset, changing the duty cycle of the clock signal. As an example, in some embodiments the duty cycle can be about 20% when the MSTR signal is set. If one of the flip signals is set, then the duty cycle can be set at 40%. If neither the MSTR signal nor one of the Flip signals are set, then the timing signal duty cycle can be about 60%. The output signal from register 806, then, is transmitted to receiver 210 through optical fiber 202.

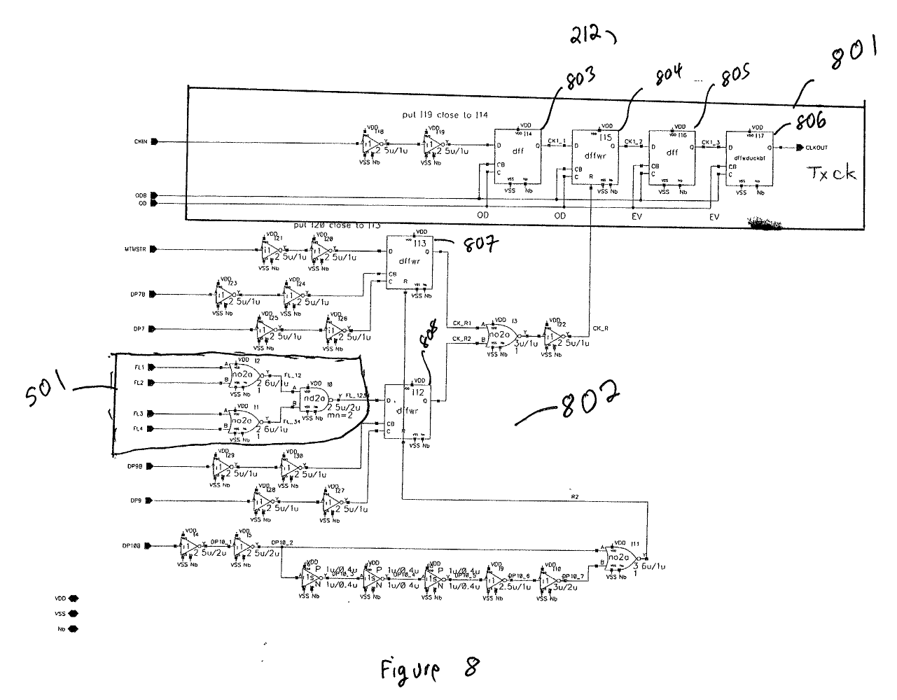

FIG. 9 shows an embodiment of clock recovery 222 of receiver 220. A start signal and a flip signal are determined in block 901. The receive clock signal CKIN is received into registers 902 and 903, which are clocked by DP5 and DP7, respectively. Clock signals DP5 and DP7 have the same frequency as the input clock signal, but differ in phase so that registers 902 and 903 capture different portions of the receive clock signal CKIN. Logic 922 determines if the flip signal or the start signal are in the received clock signal CKIN. For example, if the duty cycle is shorter than 50%, as determined by the samples captured in registers 902 and 903, then the start signal is indicated with a shortest (for example about 20%) duty cycle than that which would indicate a flip signal (for example 40%). A long duty cycle (for example about 60%) would indicate that no start signal and no flip signal are present. The signal MEN enables clock recovery 222. If MEN does not enable clock recovery 222, neither the flip signal nor the start signal are set.

If clock recovery 222 is enabled by the MEN signal, then the clock is recovered from the receive clock signal CKIN. The signal CKIN is received in register 911 and pipelined through registers 912, 914 and 910 to be output as the receive clock signal. If the Minimum Frequency Mode is enabled (e.g., the MEN signal is enabled), than a CLKOUT signal, which is the receiver's clock output and has the same duty cycle as a clock input to the transmitter, is generated from the signal DVCOB input to registers 916, and 917. A clock signal is generated from registers 918, which is serially coupled to register 917, and logic block 919. Registers 916, 917 and 918 and logic block 919 generate a clock signal which is input to register 920. Multiplexer 913 selects register 912 and 920 based on the MEN signal. Registers 911, 912, 914, 915, 916, 917 and 918 are clocked by the OD clock signal, which has a frequency three times that of the receive clock signal CKIN.

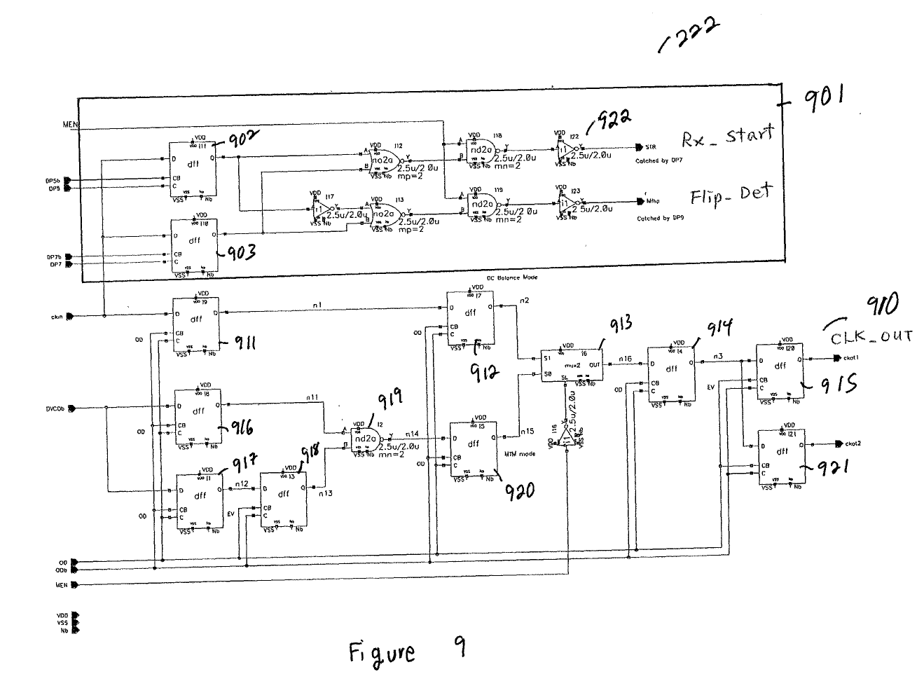

FIG. 10 shows an embodiment of sequence detector 223 of receiver 220. In structure, sequencer 223 shown in FIG. 10 is nearly the same as sequencer 213 shown in FIG. 7. Sequencer 223 includes a counter block 1020, a logic block 1010, and an enable logic block 1030. Logic block 1010 resets registers 1021, 1022, and 1023 whenever a start signal is detected in clock recovery 222. Counter block 1020, then, produces the signals S0, S1, S2, which in sequence are (0,0,0), (1, 0, 0), (1, 1, 0), (1, 1, 1), (0,1,1) before being reset to (0,0,0) again. Logic block 1030 outputs the minimum data frequency multiplexer enable signals CH1_EN through CHM_EN, which in the embodiment shown is CH1_EN through CH4_EN. Again, if S0, S1, and S2 are (1,0,0) then CH1_EN is set, if (1, 1, 0) then CH2_EN is set, if (1, 1, 1) then CH3_EN is set and if (0,1,1) then CH4_EN is set. Registers 1021, 1022, and 1023 are clocked by a clock signal DP7, which has the same frequency that parallel bits of data are presented to transmitter 210. Again, if a larger number of minimum data frequency multiplexers is included, requiring a larger number of enable signals, then counter block 1020 can include more registers coupled in series as is shown with registers 1021, 1022, and 1023.

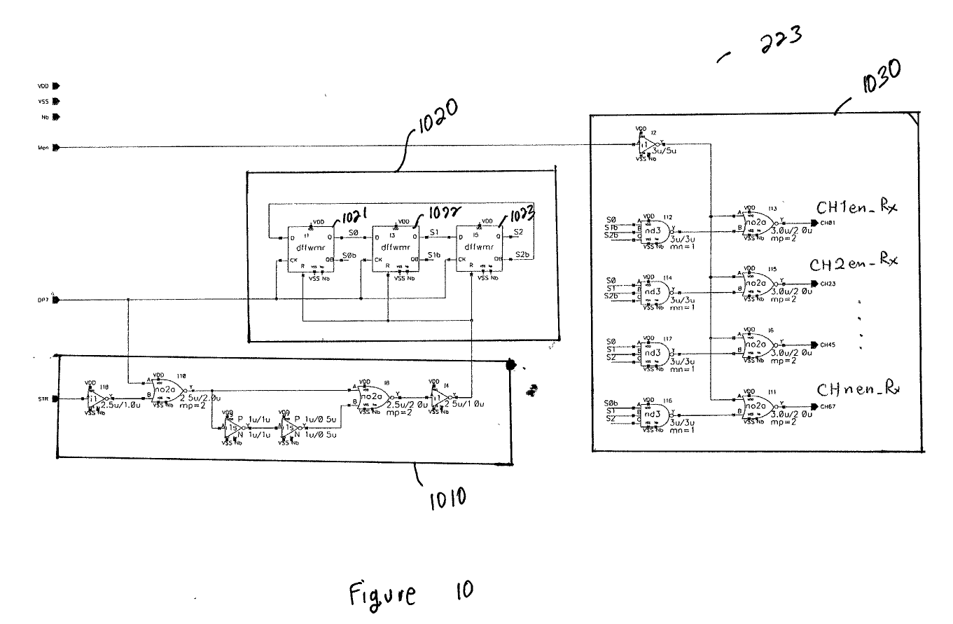

FIG. 11 shows an embodiment of deserializer 221-j according to the present invention. Deserializer 221-j includes data output section 510-j, output buffer 512-j, and logic block 513-j. Logic block 513-j receives the signal CHj_EN from sequencer 223 and the flip signal from clock recovery 222. If Chj_EN is set and the flip signal is detected, the flip is enabled and stored in register 1115. Register 1115 is clocked with a signal DP9, which has the same frequency as the clock signal transmitted to receiver 220. The serialized data received by receiver 220, CHj_RX, is received in register 1101. Register 1101 is clocked by a clock signal A1, which has a frequency six times that of the clock signal transmitted to receiver 220. The output signal from register 1101 is input to registers 1102 and 1106. Register 1102 is clocked with signal OD while register 1106 is clocked with signal ODb. Therefore, the first received bit is input to register 1102 and the second received bit is input to register 1106. In the next clock cycle, the third received bit is input to register 1102 and the fourth received bit is input to register 1106. The first received bit and the second received bit is pipelined to registers 1103 and 1109, respectively, and the inverted second received bit is pipelined to register 1108. Finally, the fifth received bit is received by register 1102 and the sixth received bit is received by register 1106, while the first four bits are pipelined through registers 1103 and 1104 or 1107 and 1109 as indicated above. Multiplexer 511-j chooses the inverted bit stream output from register 1108 or the non-inverted bit stream from register 1109 depending on whether the flip signal from register 1115 is set or not. In this fashion, those bits that were flipped in transmitter 210 are flipped again in receiver 220 to recover the originally transmitted bits. The output signal from multiplexer 511-j is received and stored in register 1110 and the output signal from register 1104 is received and stored in register 1105.

The clock signal OD has a frequency three times that of the clock signal received by receiver 220. Additionally, registers 1102 through 1105 are clocked with the opposite phase of register 1106 through 1110. The output signal from register 1105 and 1110 are input to multiplexers 1111 and 1113, respectively, which completes the deserialization of sequential data received by receiver 220. Multiplexers 1111 and 1113 sequentially direct the data output from registers 1105 and 1113, respectively, to parallel lines which are stored in buffers 1112 and 1114, respectively. When completed, buffers 1112 and 1114, then, output the parallel sets of bits B0 through B5.

Again, a larger number of parallel bits can be obtained by increasing the number of registers in the parallel paths starting with register 1102 and register 1106 or by increasing the number of parallel data paths.

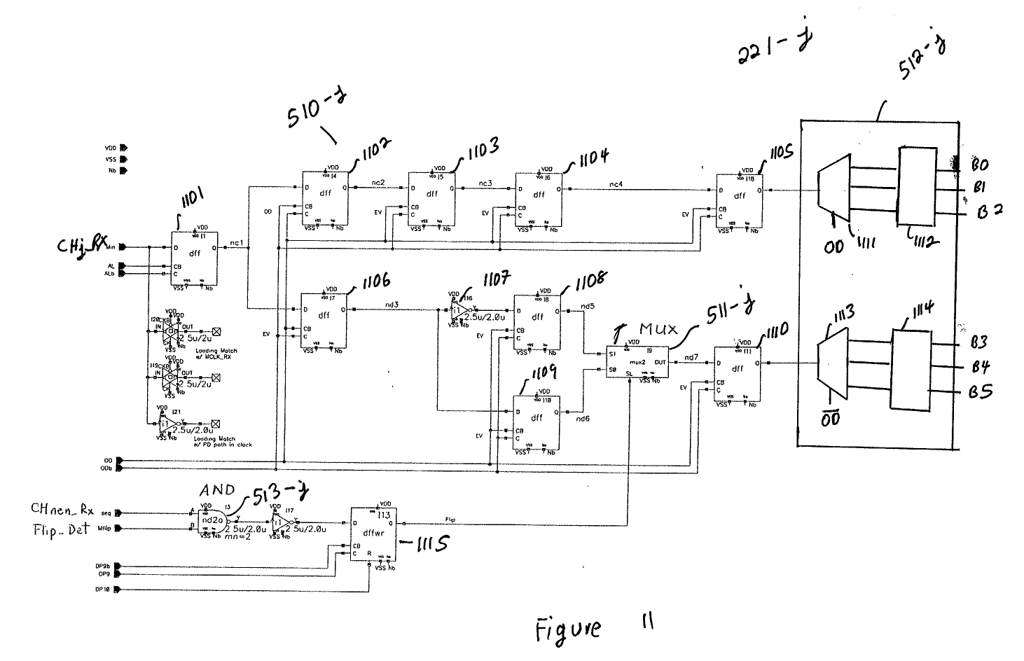

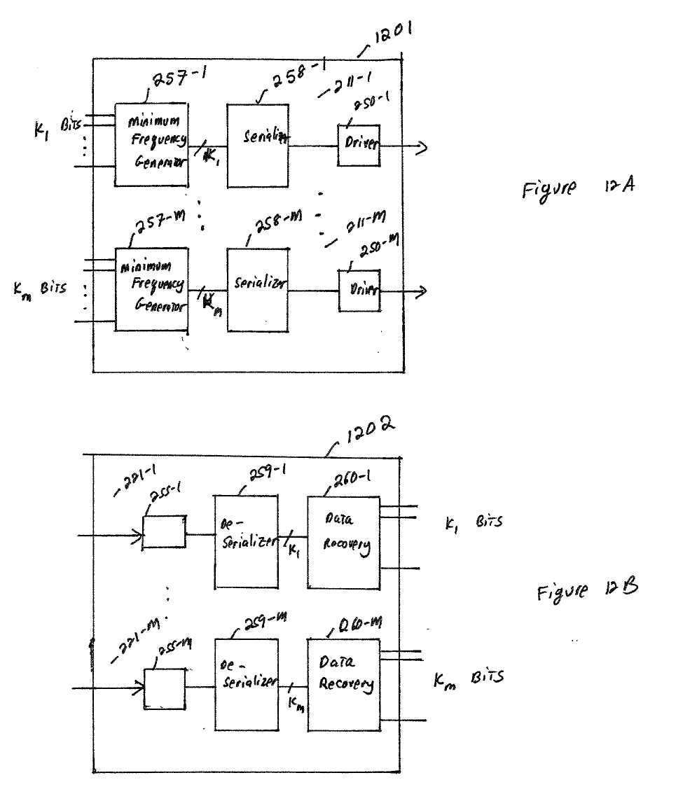

FIG. 12A shows a transmitter integrated circuit 1201. Transmitter integrated circuit 1201 includes a serializer 258 and a driver 250. In the embodiment shown in FIG. 12A, M serializers 258-1 through 258-M coupled to M drivers 250-1 through 250-M are shown formed on the chip. Each of serializers 258-1 through 258-M receive and serialize K₁ through Kₘ bits. In some embodiments of the invention, minimum frequency generators 257-1 through 257-M are also formed on integrated circuit 1201. Integrated circuit 1201 may include any number of channels 211.

FIG. 12B shows a receiver integrated circuit 1202. Receiver integrated circuit 1202 includes any number of channels 221-1 through 221-M. Integrated circuit 1202 includes amplifiers 255-1 through 255-M and deserializers 259-1 through 259-M. In some embodiments, data recovery 250-1 through 250-M are also formed on integrated circuit 1202.

The example embodiments of the invention described here are not intended to be limiting. As discussed above, one skilled in the art will recognize several variations of these embodiments which are intended to be within the spirit and scope of this disclosure. Therefore, the invention is limited only by the following claims.

We claim,

1. A method of transmitting data in a transceiver system, comprising:
receiving K parallel data bits into a transmitter minimum data frequency multiplexer, where K is an integer;
determining whether a flip condition exists;
if the flip condition exists, flipping a selected subset of the K parallel data bits;
serializing the K parallel data bits to form a serialized bit stream; and
forming a clock signal with a signal indicating whether the flip condition exists or not.

2. The method of claim 1, wherein determining whether a flip condition exists includes determining if all of the K parallel data bits are the same logic level.

3. The method of claim 2, wherein determining whether a flip condition exists further includes determining whether an enable flag is set.

4. The method of claim 1, wherein the selected subset of the K bits includes K/2 bits of the K bits.

5. The method of claim 1, wherein forming a clock signal includes changing the duty cycle of the clock signal if the flip condition exists.

6. The method of claim 5, wherein the duty cycle is reduced if the flip condition exists.

7. A method of receiving data, comprising:
receiving serialized data;
receiving a clock signal;
retrieving a flip signal from the clock signal;
flipping a subset of data bits in the serialized data if the flip signal indicates a flipped condition; and
deserializing the serialized data to form parallel data.

8. The method of claim 7, wherein retrieving the flip signal from the clock signal includes measuring the duty cycle of the clock signal; and
setting the flip signal if the duty cycle indicates a flip condition.

9. The method of claim 8, wherein a short duty cycle indicates the flip condition.

10. A transmitter, comprising:
minimum frequency sequence generator receiving parallel data;
a serializer coupled to receive data signals from the minimum frequency sequence generator to output sequential data; and
a clock generator, the clock generator producing a clock signal that indicates whether selected bits of the parallel data have been flipped in the minimum frequency sequence generator.

11. The transmitter of claim 10, wherein the minimum frequency sequence generator includes
a comparator that sets a flip signal when all of the bits of the parallel data are the same logic level; and
a flip circuit that flips bits of a subset of the parallel data when the flip signal is set.

12. The transmitter of claim 11, wherein the clock generator alters the duty cycle of the clock signal when the flip signal is set.

13. The transmitter of claim 12, wherein the duty cycle is set lower when the flip signal is set.

14. A receiver, comprising:
a clock recovery, the clock recovery recovering a clock signal and a flip signal;
a data recovery, the data recovery flipping selected bits in a received bit stream if the flip signal indicates a flipped condition.

15. The receiver of claim 14, wherein the flipped condition is detected when the duty cycle of the clock signal is lower.

16. A transmitter, comprising:
at least one channel that receives parallel data, the at least one channel including a minimum frequency generator, and a serializer coupled to receive data from the minimum frequency generator;
a sequencer, the sequencer providing an enable signal to the minimum frequency generator of each of the at least one channel; and
a clock generator, the clock generator providing a clock signal,
wherein, the minimum frequency generator of the at least one channel flips a subset of bits of the parallel data and sets a flip flag when all of the bits of the parallel data are the same logic level and the enable signal is set, and
wherein the clock generator encodes whether the flip flag for any of the at least one channels is set.

17. The transmitter of claim 16, wherein the clock generator shortens the duty cycle of the clock signal the flip flag for any of the at least one channels is set.

18. The transmitter of claim 16, wherein the sequencer enables each of the at least one channels one at a time in a sequence.

19. The transmitter of claim 18, wherein the clock generator further encodes a start signal when the sequence of the sequence generator starts.

20. The transmitter of claim 16, wherein the subset of bits includes half of the parallel bits.

21. An transmitter chip, comprising:
at least one serializer; and
at least one laser diode driver, each of the at least one laser diode driver coupled to one of the at least one serializers,
wherein the at least one serializer and the at least one laser diode driver are formed on a single integrated circuit.

22. The transmitter of claim 21, further including
at least one minimum frequency generator, each of the at least one minimum frequency generator coupled to one of the at least one serializer, the at least one minimum frequency generator formed on the single integrated circuit.

23. A receiver, comprising:
at least one transimpedance amplifier;
at least one deserializer, each of the at least one deserializer coupled to one of the at least one transimpedance amplifier,
wherein the at least one transimpedance amplifier and the at least one deserializer are formed on a single integrated circuit.

24. The receiver of claim 23, further including
at least one data recovery circuit, each of the at least one data recovery circuit coupled to one of the ate least one deserializer,
wherein the at least one data recovery circuit is formed on the single integrated circuit.

25. A receiver, comprising:
a clock recovery, the clock recovery recovering a clock signal and a flip signal from a received clock signal;
at least one channel that receives serial data, the at least one channel including a data recovery, the data recovery flipping selected bits in the serial data if the flip signal is set and the at least one channel is selected by an enable signal; and
a sequencer that provides enable signals to each of the at least one channel,
wherein, the data recovery of a selected one of the at least one channel flips bits in the serial data when the selected one of the at least one channel is selected by the enable signal.

26. The receiver of claim 25, wherein the sequencer enables each of the at least one channels one at a time in a sequence.

27. The receiver of claim 25, wherein the clock recovery further receives a start signal and wherein the sequencer restarts a sequence in response to the start signal.

28. The receiver of claim 25, wherein the flip signal is indicated by a shortened duty cycle of the received clock signal.

29 The receiver of claim 27, wherein the start signal is indicated by a short duty cycle of the received clock signal.
